(19) United States
(12) Patent Application Publication
(10) Pub. No.: US 2017/0091746 A1
(43) Pub. Date: Mar. 30, 2017

(54) COMMODITY SALES DATA PROCESSING APPARATUS AND METHOD FOR DISPLAYING TAX EXEMPTION STATE

(71) Applicant: TOSHIBA TEC KABUSHIKI KAISHA, Tokyo (JP)

(72) Inventor: Ryuji Komori, Izu Shizuoka (JP)

(21) Appl. No.: 15/258,224

(22) Filed: Sep. 7, 2016

(30) Foreign Application Priority Data
Sep. 24, 2015 (JP) 2015-186681

(51) Int. Cl. G06Q 20/20; G07G 1/00

(52) U.S. Cl. CPC G06Q 20/207; G07G 1/0045

(57) ABSTRACT

A commodity sales data processing apparatus comprises an input module configured to receive an input of a commodity code capable of identifying a commodity, a registration module configured to register the commodity identified by the commodity code received by the input module as a sales item, a determination module configured to determine whether or not a total sales amount of the commodities registered by the registration module exceeds an amount determined in a tax-free program in which the commodities are exempted from taxation if the total sales amount of the commodities exceeds the determined amount, and a display control module configured to display a tax exemption state indicating whether or not the commodities registered by the registration module are exempted from taxation according to the determination result of the determination module.

### CROSS-REFERENCE TO RELATED APPLICATION

This application is based upon and claims the benefit of priority from Japanese Patent Application No. 2015-186681, filed Sep. 24, 2015, the entire contents of which are incorporated herein by reference.

### FIELD

Embodiments described herein relate generally to a commodity sales data processing apparatus and a method for displaying a tax exemption state.

### BACKGROUND

Conventionally, in a case in which a business person who runs an export commodity store (tax-free store) sells a sales item such as a commodity to a nonresident such as a foreign tourist, there exists a so-called tax-free program in which the nonresident is exempted from paying applicable taxes such as a consumption tax and the like levied on the sales item.

In order to apply such a tax-free program, a total amount of the sales of the commodities in each category subject to the tax exemption has to be equal to or greater than a predetermined amount.

However, the total amount has to be additionally calculated to determine whether or not the total amount of the sales of the commodities in each category subject to the tax exemption reaches the predetermined amount.

### DESCRIPTION OF THE DRAWINGS

FIG. 1 is a view illustrating an example of the configuration of a POS system according to an embodiment;

FIG. 2 is a block diagram illustrating the hardware structure of a store server;

FIG. 3 is a view illustrating an example of a commodity master file;

FIG. 4 is a block diagram illustrating the hardware structure of a POS terminal;

FIG. 5 is a view illustrating an example of a sales commodity registration table;

FIG. 6 is a block diagram illustrating the characteristic functional components of each device of the POS system;

FIG. 7 is a view illustrating an example of a first commodity registration screen;

FIG. 8 is a view illustrating an example of a second commodity registration screen; and

FIG. 9 is a flowchart illustrating an example of a commodity sales data registration processing.

### DETAILED DESCRIPTION

In accordance with an embodiment, a commodity sales data processing apparatus comprises an input module, a registration module, a determination module and a display control module. The input module receives an input of a commodity code capable of identifying a commodity. The registration module registers the commodity identified by the commodity code received by the input module as a sales item. The determination module determines whether or not a total sales amount of the commodities registered by the registration module exceeds an amount determined in a tax-free program in which the commodities are exempted from taxation if the total sales amount of the commodities exceeds the determined amount. The display control module displays a tax exemption state indicating whether or not the commodities registered by the registration module are exempted from taxation according to the determination result of the determination module.

Hereinafter, the commodity sales data processing apparatus and a method for displaying a tax exemption state according to the embodiment are described in detail with reference to the accompanying drawings. The embodiment described hereinafter is one embodiment of the commodity sales data processing apparatus and the method for displaying a tax exemption state, and the configuration and specification thereof are not limited. The commodity sales data processing apparatus of the present embodiment is an example applicable to a POS (Point Of Sales) terminal, introduced into a store such as a tax-free store, which carries out a commodity sales data processing relating to a registration and settlement of a commodity relating to one transaction.

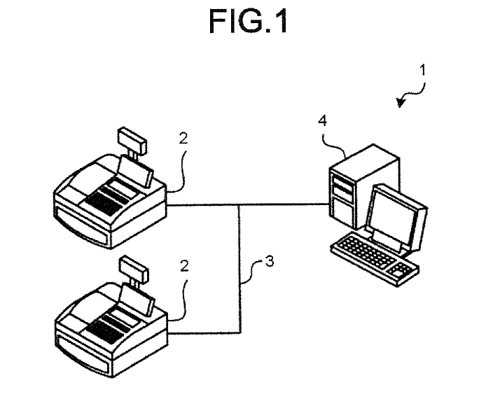

FIG. 1 is a view illustrating an example of the configuration of a POS system 1 according to the present embodiment. The POS system 1 is equipped with a POS terminal 2 and a store server 4. In the POS system, the POS terminal 2 is connected with the store server 4 via an in-store network 3. The in-store network 3 is, for example, a LAN (Local Area Network) for connecting devices arranged in the store.

The POS terminal 2 acts as a commodity sales data processing apparatus which executes a commodity sales data processing in the store such as the tax-free store that sells a commodity which is exempted from an applicable tax levied thereon. The store server 4 acts as an information processing apparatus which collectively manages the POS terminals 2 arranged in the store.

Next, the hardware structures of the POS terminal 2 and the store server 4 are described.

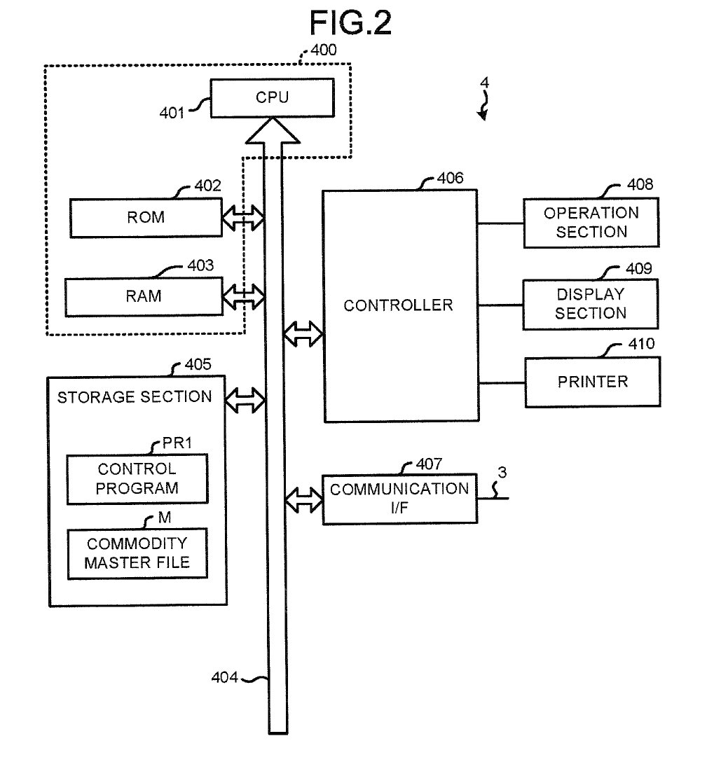

Firstly, the hardware structure of the store server 4 is described. FIG. 2 is a block diagram illustrating the hardware structure of the store server 4. The store server 4 includes a control section 400 for controlling each section thereof. As shown in FIG. 2, the control section 400 includes a CPU (Central Processing Unit) 401, a ROM (Read Only Memory) 402 and a RAM (Random Access Memory) 403. The CPU 401 is connected with the ROM 402 and the RAM 403 via a bus line 404 such as an address bus line, a data bus line and the like. The CPU 401 concentratedly controls each section. The ROM 402 is a storage medium for storing various programs and data. The RAM 403 is a storage medium for temporarily storing various programs and for rewriting various data.

The control section 400 is connected with a storage section 405, a controller 406 and a communication I/F 407 via the bus line 404.

The controller 406 is connected with an operation section 408, a display section 409 and a printer 410. The controller 406 controls each section connected therewith according to an instruction from the control section 400. The operation section 408 includes a keyboard and a mouse for inputting an operation. The display section 409 includes a liquid crystal display. The printer 410 prints various kinds of information on a sheet.

The communication I/F 407 is connected with the POS terminal 2 via the in-store network 3.

The storage section 405 includes, for example, a storage device such as an HDD (Hard Disk Drive) and an SSD (Solid State Drive). The storage section 405 stores a control program PR1 and a commodity master file M. The control program PR1 is used to realize characteristic functions of the store server 4.

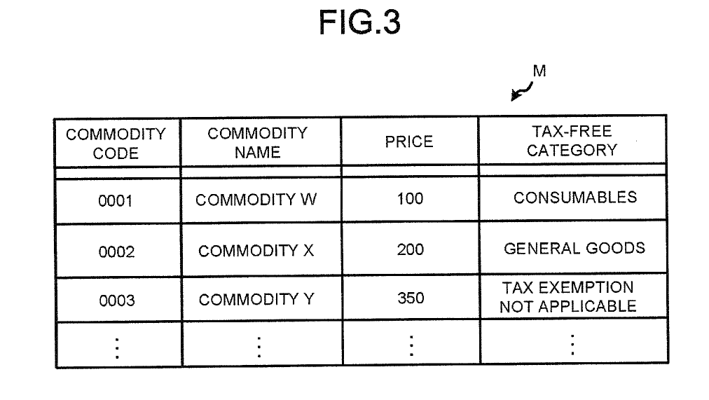

The commodity master file M is a database for storing information of each commodity. FIG. 3 is a view illustrating an example of the commodity master file M. The commodity master file M stores a commodity code, a commodity name, a price and a tax-free category in an associated manner. The commodity code is an identification information capable of identifying a commodity. The commodity name is the name of the commodity. The price is the unit price of the commodity. The tax-free category relates to the tax-free program for exempting a nonresident (foreign tourist) from paying a tax levied on a commodity to be sold to the nonresident. The tax-free category includes “consumables”, “general goods” and “tax exemption not applicable”. The “consumables” refer to foodstuffs, beverages, chemicals, cosmetics and other commodities. The “general goods”, which are tax exemption applicable items, correspond to commodities used in the common life other than the consumables. For example, the “general goods” correspond to household appliances, clothes, bags and other commodities. The “tax exemption not applicable” is a commodity serving as a non-tax-free item or goods. Further, the tax-free category described above is one example, and there may be another category other than the above.

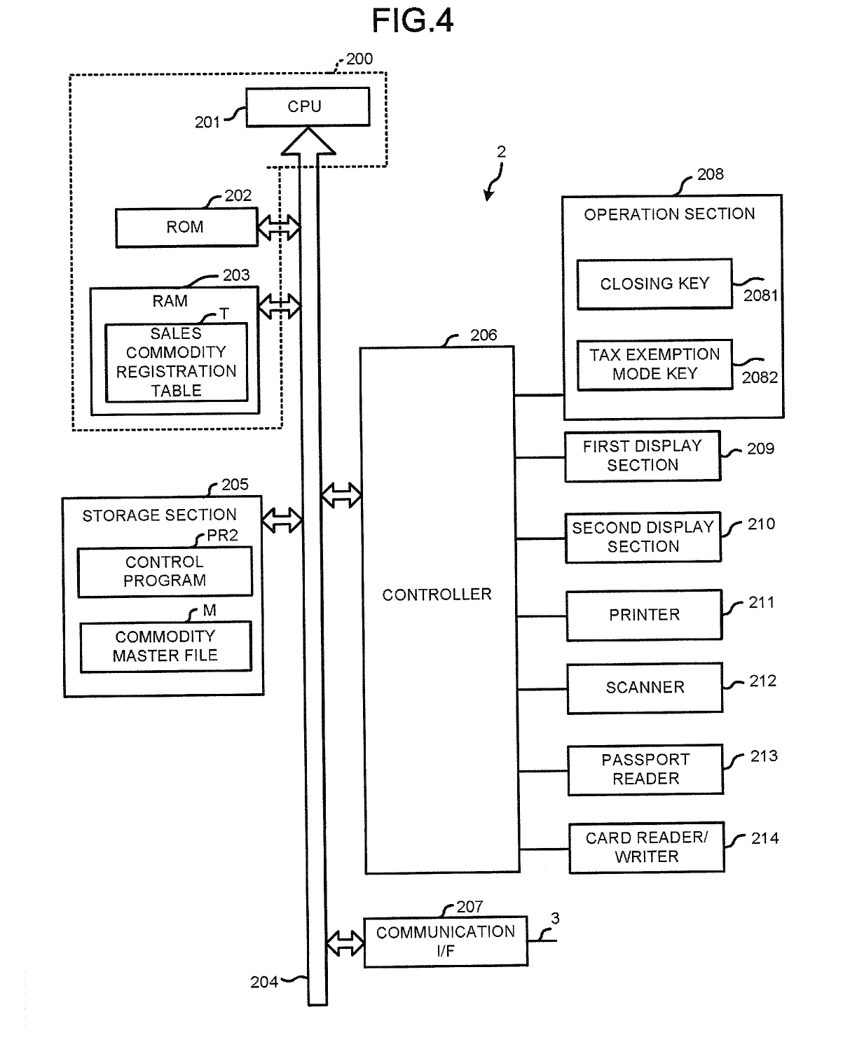

Next, the hardware structure of the POS terminal 2 is described. FIG. 4 is a block diagram illustrating the hardware structure of the POS terminal 2. The POS terminal 2 includes a control section 200 for controlling each section thereof. As shown in FIG. 4, the control section 200 includes a CPU 201, a ROM 202 and a RAM 203. The CPU 201 is connected with the ROM 202 and the RAM 203 via a bus line 204 such as an address bus line, a data bus line and the like. The CPU 201 concentratedly controls each section. The ROM 202 is a storage medium for storing various programs and data. The RAM 203 is a storage medium for temporarily storing various programs and for rewriting various data. Further, a part of the area of the RAM 203 is used to store a sales commodity registration table T.

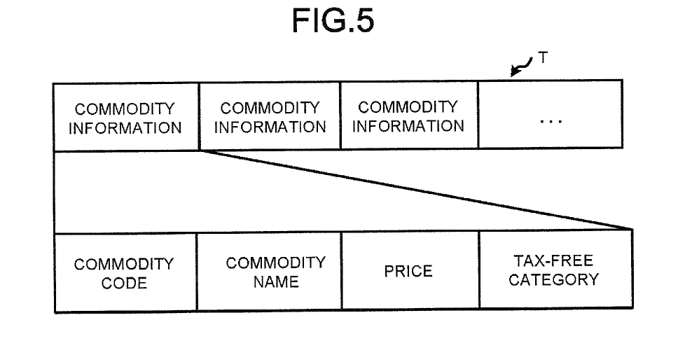

The sales commodity registration table T stores a commodity, i.e., a sales item. FIG. 5 is a view illustrating an example of the sales commodity registration table T. The sales commodity registration table T stores commodity information for each commodity. The commodity information is respectively associated with the commodity code, the commodity name, the price and the tax-free category.

The control section 200 is connected with a storage section 205, a controller 206 and a communication I/F 207 via the bus line 204.

The controller 206 is connected with an operation section 208, a first display section 209, a second display section 210, a printer 211, a scanner 212, a passport reader 213 and a card reader/writer 214. The operation section 208 includes a keyboard and a mouse for inputting an operation. The operation section 208 is equipped with a closing key 2081 and a tax exemption mode key 2082. The closing key 2081 is used to terminate registration of the commodities to calculate a total amount of the sales. The tax exemption mode key 2082 is set for a tax exemption mode. In the tax exemption mode, it is determined whether or not it is a transaction to which the tax-free program can be applied in the commodity sales data registration processing.

The first display section 209 and the second display section 210 include display devices such as a liquid crystal device. The first display section 209 and the second display section 210 displays various kinds of information such as a name and a price of a commodity registered through the commodity sales data processing, a total amount of one transaction of which the settlement is declared and a change amount. The first display section 209 mainly displays various kinds of information to a store clerk. The second display section 210 mainly displays various kinds of information to a customer. The first display section 209 and the second display section 210 each may be equipped with a touch panel. In this case, the touch panel functions as the operation section 208.

The printer 211 prints a receipt and a journal. The printer 211 prints receipt information on a paper such as a rolled paper and outputs the paper receipt.

The scanner 212 is a laser type handy scanner or an optical reading type vertical scanner. The scanner 212 optically reads a code symbol such as a barcode and a two-dimensional code attached to a commodity.

The passport reader 213 reads information held on a passport. In the embodiment, the passport reader 213 includes an OCR (Optical Character Recognition) function for optically reading a character string on the passport.

The card reader/writer 214 reads/writes information held in a storage medium of a card.

The communication I/F 207 is connected with the store server 4 via the in-store network 3.

The storage section 205 is, for example, a storage device such as an HDD and an SSD. The storage section 205 stores a control program PR2 and a commodity master file M. The control program PR2 is used to realize characteristic functions of the POS terminal 2. The commodity master file M is kept in the storage section 405 of the store server 4 and sent from the store server 4 to the POS terminal 2.

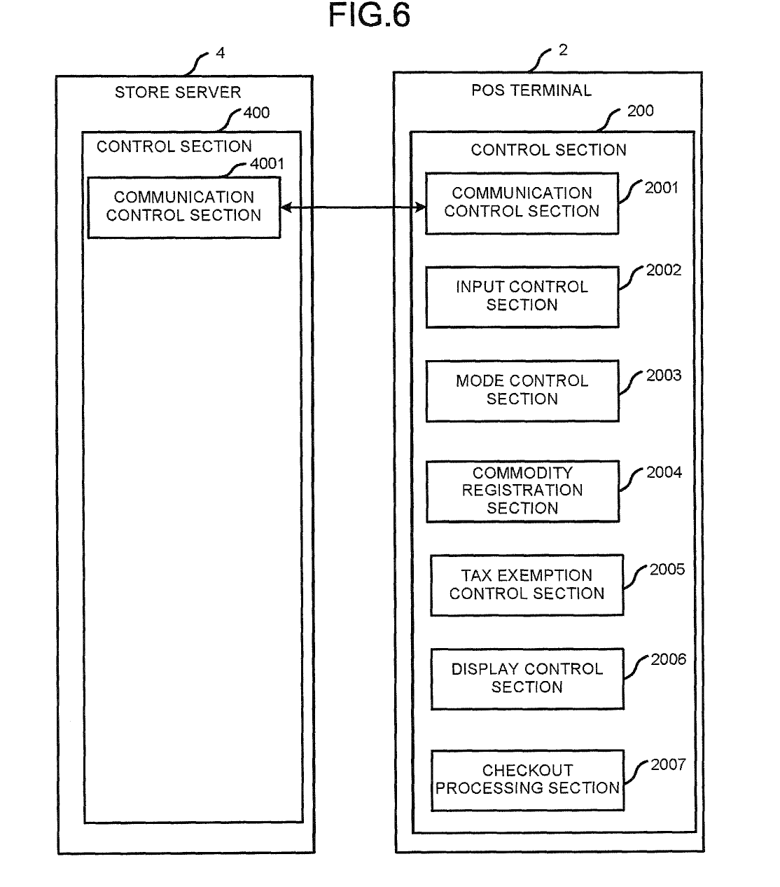

Next, the characteristic functions of each device of the POS system 1 are described. FIG. 6 is a block diagram illustrating the characteristic functional components of each device of the POS system 1.

Firstly, the characteristic functions of the store server 4 are described.

The CPU 401 of the control section 400 copies or decompresses the control program PR1 stored in the storage section 405 on the RAM 403 and operates according to the control program PR1 to generate each functional section shown in FIG. 6 on the RAM 403. Specifically, the control section 400 is equipped with a communication control section 4001 as the functional section.

The communication control section 4001 controls the communication I/F 407 to carry out a communication via the in-store network 3. For example, the communication control section 4001 regularly sends the commodity master file M to the POS terminal 2.

Next, the characteristic functions of the POS terminal 2 are described.

The CPU 201 of the control section 200 copies or decompresses the control program PR2 stored in the storage section 205 on the RAM 203 and operates according to the control program PR2 to generate each functional section shown in FIG. 6 on the RAM 203. Specifically, the control section 200 comprises a communication control section 2001, an input control section 2002, a mode control section 2003, a commodity registration section 2004, a tax exemption control section 2005, a display control section 2006 and a checkout processing section 2007 as the functional sections.

The communication control section 2001 controls the communication I/F 207 to carry out a communication via the in-store network 3. For example, the communication control section 2001 regularly receives the commodity master file M from the store server 4.

The input control section 2002 serving as an input module receives the input of the commodity code from the scanner 212. Alternatively, the input control section 2002 receives the input of the commodity code from the operation section 208. The input control section 2002 also receives the input for setting the tax exemption mode from the tax exemption mode key 2082. Furthermore, the input control section 2002 receives the input for terminating the registration of the commodity, i.e., the sales item, from the closing key 2081 to calculate the total amount of the sales.

The mode control section 2003 controls a mode change. Specifically, the mode control section 2003 sets the POS terminal 2 to the tax exemption mode if the input control section 2002 receives the input for setting the tax exemption mode. Then, the mode control section 2003 sets the POS terminal 2 to a normal mode if the commodity sales data registration processing in the tax exemption mode is completed. The normal mode refers to a mode in which whether or not it is a transaction to which the tax-free program can be applied in the commodity sales data registration processing is not determined.

The commodity registration section 2004 serving as a registration module registers the commodity identified by the commodity code received by the input control section 2002 in the sales commodity registration table T. If the input control section 2002 receives the commodity code of the commodity, the commodity registration section 2004 reads out the information associated with the commodity code from the commodity master file M. Then, the commodity registration section 2004 registers the information relating to the commodity in the sales commodity registration table T. In this way, the commodity registration section 2004 registers the commodity identified by the commodity code received by the input control section 2002 in the sales commodity registration table T as the sales item.

The tax exemption control section 2005 determines whether or not the tax-free program can be applied to the commodity if the POS terminal 2 is set to the tax exemption mode. Specifically, the tax exemption control section 2005 calculates the total amount of the sales of the commodities registered in the sales commodity registration table T for each tax-free category. Then, the tax exemption control section 2005 serving as a determination module determines whether or not the total amount of the sales of the commodities belonging to each tax-free category is within the range of the tax-free reference amount. In other words, the tax exemption control section 2005 determines whether or not the total amount of the sales of the commodities belonging to each tax-free category exceeds the lower limit of the tax-free reference amount. Further, the tax exemption control section 2005 determines whether or not the total amount of the sales of the commodities belonging to each tax-free category does not exceed the upper limit of the tax-free reference amount. If the total amount of the sales of the commodities is within the range of the tax-free reference amount, the tax exemption control section 2005 determines that the commodities belonging to the tax-free category are the tax exemption (tax-free program) applicable items. On the other hand, if the total amount of the sales of the commodities belonging to a tax-free category is beyond the range of the tax-free reference amount, the tax exemption control section 2005 determines that the commodities belonging to the tax-free category are not the tax exemption (tax-free program) applicable items. The tax-free reference amount refers to an amount serving as a threshold value determined in the tax-free program in which the tax exemption is applied. In other words, the tax-free reference amount refers to an amount serving as a reference for determining whether or not the exemption from paying the tax levied on the commodity in the tax-free category is applied. The tax-free reference amount can be set to a different amount for each tax-free category. For example, regarding the tax-free reference amount, 5,000 yen to 500,000 yen is set for the tax-free category “consumables” in advance, and 10,000 yen is set for the tax-free category “general goods” in advance. The tax exemption control section 2005 calculates a tax-free amount for each tax-free category.

The tax exemption control section 2005 calculates a general goods tax exemption applicable amount, a consumables tax exemption applicable amount, a general goods tax exemption application balance, a consumables tax exemption application balance, a total tax exemption applicable amount and a tax-free amount. Then, the tax exemption control section 2005 displays the calculated amount on the first display section 209 and the second display section 210. In this way, the store clerk and the customer can grasp the state of the tax exemption. The general goods tax exemption applicable amount refers to an amount indicating a tax exemption applicable amount of the commodities belonging to the tax-free category “general goods”. The consumables tax exemption applicable amount refers to an amount indicating a tax exemption applicable amount of the commodities belonging to the tax-free category “consumables”. The general goods tax exemption application balance refers to an amount indicating a balance up to the tax-free reference amount of the general goods required to receive the application of the tax-free program. In other words, the general goods tax exemption application balance refers to an amount obtained by subtracting the total amount of the sales of the commodities belonging to the tax-free category from the tax-free reference amount. The consumables tax exemption application balance refers to an amount indicating a balance up to the tax-free reference amount of the consumables required to receive the application of the tax-free program. In other words, the consumables tax exemption application balance refers to an amount obtained by subtracting the total amount of the sales of the commodities belonging to the tax-free category from the tax-free reference amount. A total tax exemption applicable amount refers to an amount obtained by adding up all the amount of the tax exemption applicable items belonging to the tax-free categories. The tax-free amount refers to an amount which is exempted from taxation. The tax-free amount refers to a total amount of the tax-free amount relating to the commodities belonging to the tax-free category “general goods” and the tax-free amount relating to the commodities belonging to the tax-free category “consumables”.

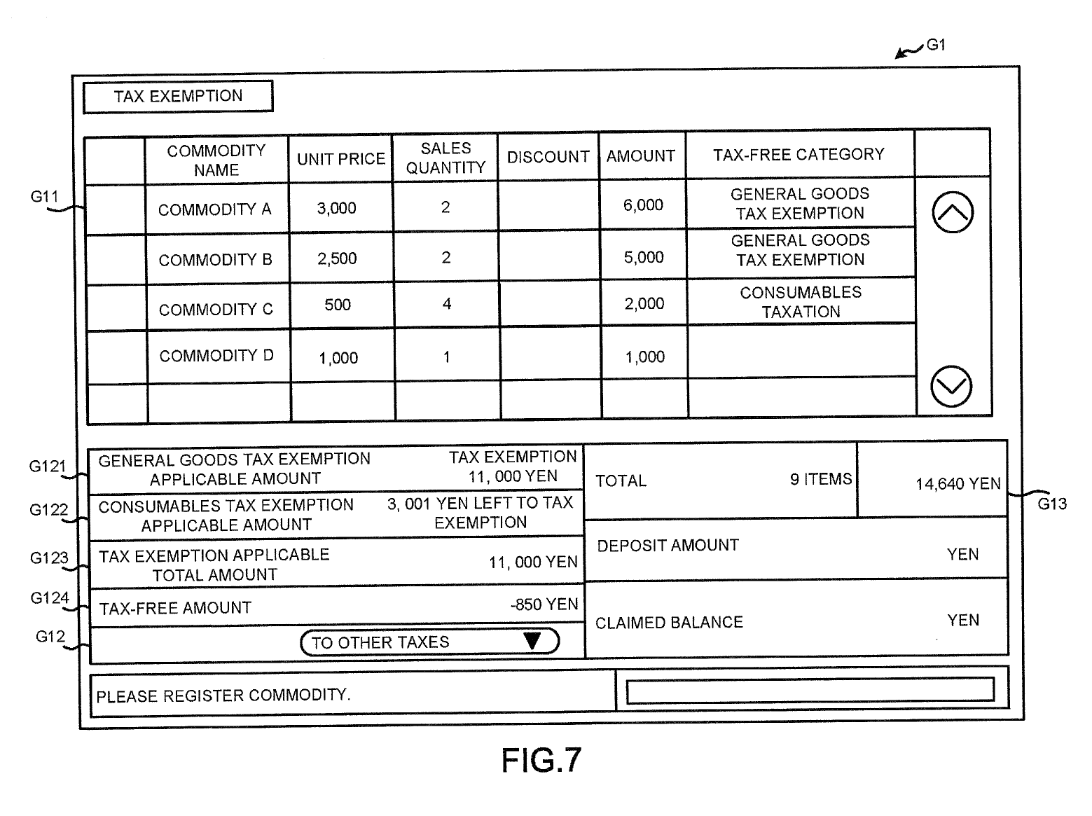

The display control section 2006 displays various screens on the first display section 209 and the second display section 210. The display control section 2006 serving as a display control module displays, for example, a first commodity registration screen on the first display section 209 mainly seen by the store clerk. FIG. 7 is a view illustrating an example of a first commodity registration screen G1. The first commodity registration screen G1 displays the state of the tax exemption indicating whether or not the commodity (sales item) is exempted from the taxation according to a determination result of the tax exemption control section 2005 in the commodity sales data registration processing set in the tax exemption mode.

The first commodity registration screen G1 includes a commodity list display area G11, a tax exemption information display area G12 and a total amount display area G13 if roughly classified. The commodity list display area G11 displays commodity information of the commodity registered in the sales commodity registration table T. The commodity list display area G11 includes columns for additionally displaying a commodity name, a unit price, a sales quantity, discount, an amount and a tax-free category for each commodity. In the column “commodity name”, a commodity name is displayed. In the column “unit price”, a price of a commodity is displayed. In the column “sales quantity”, a sales quantity is displayed. In the column “discount”, a discount amount or a discount rate is displayed in a case in which the price of the commodity is discounted. In the column “amount”, an amount obtained by multiplying the sales quantity by the price of the commodity is displayed. In the column “tax-free category”, a tax-free category to which a commodity belongs is displayed. The commodity list display area G11 shown in FIG. 7 indicates that a commodity A and a commodity B belong to the general goods, a commodity C belongs to the consumables, and a commodity D belongs to the non-tax exemption applicable item.

Then, the display control section 2006 displays the tax exemption state indicating whether or not a commodity is exempted from the taxation for each commodity registered in the sales commodity registration table T on the commodity list display area G11. The display control section 2006 displays the tax exemption state of the commodity list display area G11 in different display forms according to whether a commodity is exempted from the taxation. The different display forms of the tax exemption state of the commodity list display area G11 include, for example, change of a color, addition of a character string, display of animation, addition of a mark, change of a font, change of a display size and the like. In the first commodity registration screen G1 shown in FIG. 7, as a display form capable of recognizing whether or not a commodity is the tax exemption applicable item, “tax exemption” is displayed for a commodity of the tax exemption applicable item, and “taxation” is displayed for a commodity of the non-tax exemption applicable item. The first commodity registration screen G1 shown in FIG. 7 indicates that the commodity A and the commodity B are the commodities of the tax exemption applicable items.

The tax exemption information display area G12 displays information relating to tax exemption of the commodity registered in the sales commodity registration table T. The tax exemption information display area G12 includes a general goods tax exemption applicable amount column G121, a consumables tax exemption applicable amount column G122, a tax exemption applicable total amount column G123 and a tax-free amount column G124. The general goods tax exemption applicable amount column G121 and the consumables tax exemption applicable amount column G122 respectively display the amount of the tax exemption applicable item which is exempted from the taxation for each tax-free category.

The general goods tax exemption applicable amount column G121 displays the general goods tax exemption applicable amount or the general goods tax exemption application balance. The display control section 2006 displays the tax exemption state indicating whether or not the general goods tax exemption applicable amount or the general goods tax exemption application balance is subject to the tax exemption in the general goods tax exemption applicable amount column G121. Further, the display control section 2006 displays the tax exemption state of the general goods tax exemption applicable amount column G121 in different display forms according to whether the commodity is exempted from the taxation. In other words, the display control section 2006 displays the general goods tax exemption applicable amount in the general goods tax exemption applicable amount column G121 together with a message “tax exemption” if the commodity belonging to the tax-free category “general goods” is exempted from the taxation. On the other hand, the display control section 2006 displays the general goods tax exemption application balance in the general goods tax exemption applicable amount column G121 together with a message “left to tax exemption” if the total amount of the commodities belonging to the tax-free category “general goods” does not exceed the tax free reference amount and thus the tax exemption is not applied to. The general goods tax exemption applicable amount column G121 shown in FIG. 7 displays “tax exemption 11,000 yen”. Furthermore, the different display forms of the tax exemption state of the general goods tax exemption applicable amount column G121 are not limited to the above, but may include the change of the color, the addition of the character string, the display of the animation, the addition of the mark, the change of the font, the change of the display size and the like.

The consumables tax exemption applicable amount column G122 displays the consumables tax exemption applicable amount or the consumables tax exemption application balance. The display control section 2006 displays the tax exemption state indicating whether or not the consumables tax exemption applicable amount or the consumables tax exemption application balance is subject to the tax exemption in the consumables tax exemption applicable amount column G122. Further, the display control section 2006 displays the tax exemption state of the consumables tax exemption applicable amount column G122 in different display forms according to whether the commodity is exempted from the taxation. In other words, the display control section 2006 displays the consumables tax exemption applicable amount in the consumables tax exemption applicable amount column G122 together with the message “tax exemption” if the commodity belonging to the tax-free category “consumables” is exempted from the taxation. On the other hand, the display control section 2006 displays the consumables tax exemption application balance in the consumables tax exemption applicable amount column G122 together with the massage “left to tax exemption” if the total amount of the commodities belonging to the tax-free category “consumables” is not greater than the tax-free reference amount and thus the tax exemption is not applied to. In the consumables tax exemption applicable amount column G122 shown in FIG. 7, “3,001 yen left to tax exemption” is displayed. Furthermore, the different display forms of the tax exemption state of the consumables tax exemption applicable amount column G122 are not limited to the above, but may include the change of the color, the addition of the character string, the display of the animation, the addition of the mark, the change of the font, the change of the display size and the like.

The tax exemption applicable total amount column G123 displays the tax exemption applicable amount of all the commodities to which the tax exemption is applied. The tax exemption applicable total amount column G123 shown in FIG. 7 displays “11,000 yen”. The tax-free amount column G124 displays the total amount exempt from the taxation in one transaction. The tax-free amount column G124 shown in FIG. 7 displays “−850 yen”.

The total amount display area G13 displays the total amount of the sales of the commodities registered in the sales commodity registration table T. The total amount display area G13 includes a total commodity sales quantity display column, a total amount display column, a deposit amount display column and a claimed balance display column. The total commodity sales quantity display column displays the total sales quantity of the commodities registered in the sales commodity registration table T. The total amount display column displays the total amount of the sales of the commodities registered in the sales commodity registration table T. The deposit amount display column displays a deposit amount received from the customer. The claimed balance display column displays a claimed balance.

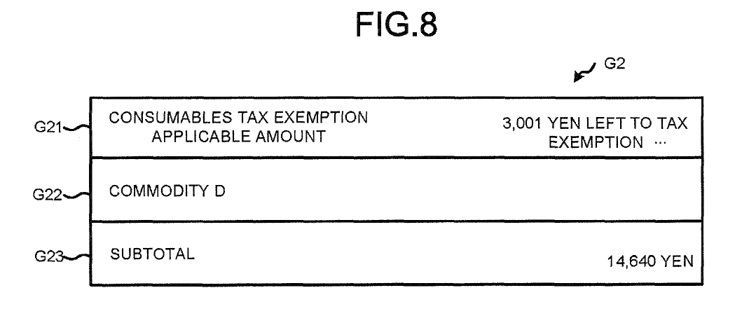

Otherwise, the display control section 2006 displays, for example, a second commodity registration screen on the second display section 210 which can be seen mainly by the customer. FIG. 8 is a view illustrating an example of a second commodity registration screen G2. The second commodity registration screen G2 includes a tax exemption information display area G21, a commodity display area G22 and a total amount display area G23. The tax exemption information display area G21 displays information relating to the tax exemption of the commodity registered in the sales commodity registration table T. As the display area of the tax exemption information display area G21 is narrow, the display control section 2006 displays the information relating to the tax exemption of the commodity registered in the sales commodity registration table T in a scrolling manner. In other words, the display control section 2006 scroll-displays, for example, “general goods tax exemption applicable amount, tax exemption 11,000 yen, consumables tax exemption applicable amount 3,001 yen left to tax exemption, tax exemption applicable total amount 11,000 yen, tax-free amount −850 yen”. The commodity display area G22 displays the name of the commodity latest registered in the sales commodity registration table T. The total amount display area G23 displays the total amount of the commodity registered in the sales commodity registration table T.

As the display area of the second display section 210 is narrow, the display control section 2006 displays information in a scrolling manner. However, the display method is not limited to this. The display control section 2006 may display a screen identical to the tax exemption information display area G12 of the first commodity registration screen G1 on the second display section 210.

The checkout processing section 2007 executes a checkout processing. The checkout processing includes a processing of receiving the payment for a price from which a tax-free amount is deducted and a processing of printing a receipt indicating that the payment of the price is received.

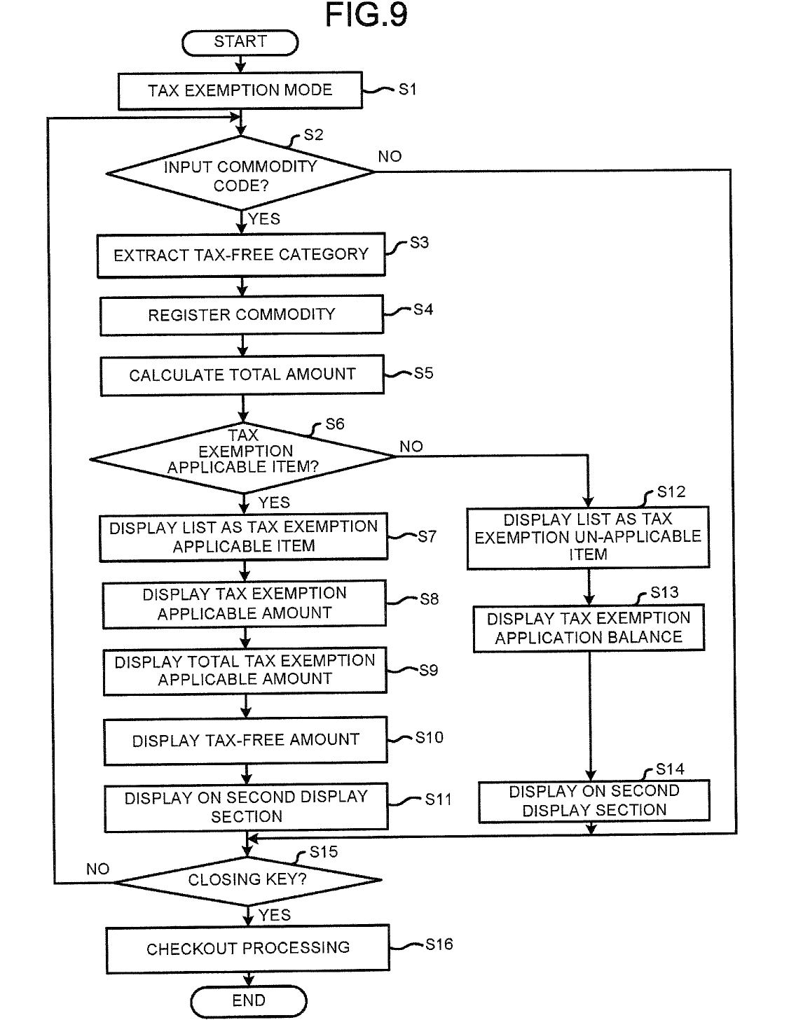

Next, the commodity sales data registration processing executed by the POS terminal 2 is described. FIG. 9 is a flowchart illustrating an example of the commodity sales data registration processing executed by the POS terminal 2 according to the embodiment.

Firstly, the mode control section 2003 of the POS terminal 2 sets the POS terminal 2 to the tax exemption mode if the press on the tax exemption mode key 2082 is detected (Act S1).

Next, the commodity registration section 2004 of the POS terminal 2 determines whether or not the commodity code is input (Act S2). If it is determined that the commodity code is not input (No in Act S2), the commodity registration section 2004 of the POS terminal 2 proceeds to the processing in Act S15.

On the other hand, if it is determined that the commodity code is input (Yes in Act S2), the commodity registration section 2004 of the POS terminal 2 extracts information associated with the input commodity code from the commodity master file M (Act S3).

Then, the commodity registration section 2004 of the POS terminal 2 registers the information extracted from the commodity master file M in the sales commodity registration table T as the commodity information (Act S4).

Next, the tax exemption control section 2005 of the POS terminal 2 calculates the total amount of the sales of the tax-free category of the commodities registered in the sales commodity registration table T (Act S5).

After that, the tax exemption control section 2005 of the POS terminal 2 determines whether or not the total amount of the sales of the tax-free category exceeds the tax-free reference amount (Act S6). In other words, the tax exemption control section 2005 of the POS terminal 2 determines whether or not the commodities belonging to the tax-free category in the commodities registered in the sales commodity registration table T are subject to the tax exemption.

If it is determined that the commodities belonging to the tax-free category in the commodities registered in the sales commodity registration table T are subject to the tax exemption (Yes in Act S6), the display control section 2006 of the POS terminal 2 displays the commodities in the commodity list display area G11 in a form capable of recognizing that the commodities are subject to the tax exemption (Act S7).

Next, the display control section 2006 of the POS terminal 2 displays the tax exemption applicable amount in a display form capable of recognizing that the tax exemption applicable amount is subject to the tax exemption (Act S8). In other words, the display control section 2006 displays the general goods tax exemption applicable amount in the general goods tax exemption applicable amount column G121 in the display form capable of recognizing that the general goods tax exemption applicable amount is subject to the tax exemption. Otherwise, the display control section 2006 displays the consumables tax exemption applicable amount in the consumables tax exemption applicable amount column G122 in the display form capable of recognizing that the consumables tax exemption applicable amount is subject to the tax exemption.

Then, the display control section 2006 of the POS terminal 2 displays the total tax exemption applicable amount in the tax exemption applicable total amount column G123 (Act S9).

After that, the display control section 2006 of the POS terminal 2 displays the tax-free amount in the tax-free amount column G124 (Act S10).

Subsequently, the display control section 2006 of the POS terminal 2 displays the information relating to the tax exemption displayed through the processing from Act S8 to Act S10 on the second display section 210 (Act S11). A timing at which the display control section 2006 displays the second display section 210 the information relating to the tax exemption on the second display section 210 is not limited to the above, but may be the same as the timing at which the processing from Act S8 to Act S10 is executed. Otherwise, the display control section 2006 may display the information relating to the tax exemption on the second display section 210 before the processing from Act S8 to Act S10 is executed.

On the other hand, if it is determined that the commodities belonging to the tax-free category of the commodities registered in the sales commodity registration table T are not subject to the tax exemption (No in Act S6), the display control section 2006 of the POS terminal 2 displays the tax exemption state in the commodity list display area G11 in a display form capable of recognizing that the commodity is not subject to the tax exemption (Act S12).

Next, the display control section 2006 of the POS terminal 2 displays in the display form capable of recognizing that the tax exemption application balance is not subject to the tax exemption (Act S13). In other words, the display control section 2006 displays the general goods tax exemption application balance in the general goods tax exemption applicable amount column G121 in the display form capable of recognizing that the general goods tax exemption application balance is not subject to the tax exemption. Otherwise, the display control section 2006 displays the consumables tax exemption application balance in consumables tax exemption applicable amount column G122 in the display form capable of recognizing that the consumables tax exemption application balance is not subject to the tax exemption.

Then, the display control section 2006 of the POS terminal 2 displays the information relating to the tax exemption displayed through the processing in Act S13 on the second display section 210 (Act S14). A timing at which the display control section 2006 displays the information relating to the tax exemption on the second display section 210 is not limited to the above, but may be the same as the timing at which the processing in Act S13 is executed. Otherwise, the display control section 2006 may display the information relating to the tax exemption on the second display section 210 before the processing in Act S13 is executed.

Afterwards, the input control section 2002 of the POS terminal 2 determines whether or not the press on the closing key 2081 is detected (Act S15). If it is determined that the press on the closing key 2081 is not detected (No in Act S15), the input control section 2002 of the POS terminal 2 proceeds to the processing in Act S2.

If it is determined that the press on the closing key 2081 is detected (Yes in Act S15), the checkout processing section 2007 of the POS terminal 2 executes the checkout processing such as the processing of receiving the payment for the price from which the tax-free amount is deducted (Act S16).

Through the above-described processing, the POS terminal 2 terminates the commodity sales data registration processing.

As described above, according to the POS terminal 2 of the present embodiment, the commodity registration section 2004 extracts the information associated with the commodity code received by the input control section 2002 from the commodity master file M to register the information in the sales commodity registration table T. The tax exemption control section 2005 determines whether or not the total amount of the sales of the commodity or commodities registered in the sales commodity registration table T exceeds the amount determined in the tax-free program. Then, the display control section 2006 displays the tax exemption state indicating whether or not the commodity or commodities, i.e., sales item, is exempted from the applicable tax according to the determination result of the tax exemption control section 2005 on the first commodity registration screen G1. Thus, the POS terminal 2 of the present embodiment can execute the output indicating whether or not the commodity, i.e., sales item, is subject to the tax exemption. Therefore, the store clerk can inform the customer of the tax exemption state of the commodities to be purchased, e.g., tax exemption/non-tax exemption. Furthermore, the customer himself/herself can also recognize whether or not he or she is exempted from the taxation.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

The programs executed by each device of the foregoing embodiment and the modification may be incorporated into a storage medium (ROM or storage section) of each device to be provided; however, the present invention is not limited to this. The programs may be recorded in a computer-readable recording medium such as a CD-ROM, an FD (Flexible Disk), a CD-R, a DVD (Digital Versatile Disk) and the like in the form of installable or executable file to be provided. Further, the storage medium is not limited to a medium independent from a computer or an embedded system and also contains a storage medium that stores or temporarily stores the programs by downloading the programs transmitted through an LAN or an Internet.

Further, the programs executed by each device of the foregoing embodiment and the modification is stored in a computer connected with a network and downloaded via the network to be supplied or may be supplied or distributed via the network such as the Internet.

What is claimed is:

1. A commodity sales data processing apparatus, comprising:
an input module configured to receive an input of a commodity code capable of identifying a commodity;
a registration module configured to register the commodity identified by the commodity code received by the input module as a sales item;
a determination module configured to determine whether or not a total sales amount of commodities registered by the registration module exceeds an amount determined in a tax-free program in which the commodities are exempted from taxation if the total sales amount of the commodities exceeds the determined amount; and
a display control module configured to display a tax exemption state indicating whether or not the commodities registered by the registration module are exempted from taxation according to the determination result of the determination module.

2. The commodity sales data processing apparatus according to claim 1, wherein the display control module displays the tax exemption state in different display forms according to whether the commodities are exempted from taxation.

3. The commodity sales data processing apparatus according to claim 1, wherein the display control module adds a category of the commodity according to the tax-free program to the commodity registered by the registration module to display the category.

4. The commodity sales data processing apparatus according to claim 2, wherein the display control module adds a category of the commodity according to the tax-free program to the commodity registered by the registration module to display the category.

5. The commodity sales data processing apparatus according to claim 3, wherein the display control module displays an amount of the commodity which is subject to the tax exemption if the commodities registered by the registration module are exempted from taxation.

6. The commodity sales data processing apparatus according to claim 1, wherein the display control module displays an amount required to exceed the amount determined in the tax-free program if the total amount of the commodities registered by the registration module does not exceed the amount determined in the tax-free program.

7. A method for displaying a tax exemption state including:
receiving an input of a commodity code capable of identifying a commodity;
registering the commodity identified by the received commodity code as a sales commodity;
determining whether or not a total sales amount of the registered commodities exceeds an amount determined in a tax-free program in which the sales commodities are exempted from taxation if the total sales amount of the commodities exceeds the determined amount; and
displaying a tax exemption state indicating whether or not the commodities registered by the registration module are exempted from taxation according to the determination result.
